(19) United States
(12) Patent Application Publication
(10) Pub. No.: US 2026/0157376 A1
(43) Pub. Date: Jun. 11, 2026

(54) METHOD OF CONTROLLING, LIMITING OR PREVENTING OOMYCETES

(71) Applicant: SYNGENTA CROP PROTECTION AG, Basel (CH)

(72) Inventors: Brigitte SLAATS, Basel (CH); Pieter BOGAERTS, Gent (BE); Renu KAPIL, Basel (CH); Dimitrios DRAKOPOULOS, Stein (CH)

(73) Assignee: SYNGENTA CROP PROTECTION AG, Basel (CH)

(21) Appl. No.: 19/125,520

(22) PCT Filed: Oct. 30, 2023
(86) PCT No.: PCT/EP2023/080245

§ 371 Date: Apr. 29, 2025

(30) Foreign Application Priority Data
Nov. 2, 2022 (EP) 22204977.7
Oct. 3, 2023 (GR) 20230100798

(51) Int. Cl. A01N 59/26; A01N 37/26; A01N 43/56; A01P 15/00

(52) U.S. Cl. CPC A01N 59/26; A01N 37/26; A01N 43/56; A01P 15/00

(57) ABSTRACT

This invention relates to a method of controlling, limiting or preventing an infestation of a plant by oomycetes, which comprises applying to propagation material of said plant, a fungicidally effective amount of a phosphorus-based compound.

This invention relates to a method of controlling, limiting or preventing an infestation of plants by phytopathogenic microorganisms, such as oomycetes, in treating plant propagation material, and to a seed treatment use.

Metalaxyl-M, also referred to as Mefenoxam, is a well-known seed treatment against oomycetes. However, it has been found that oomycetes, and more particularly Pythium diseases caused by Pythium species, develop a chemical resistance to Metalaxyl-M especially with leafy vegetables, legume crops and oil crops, so that the biological efficacy of Metalaxyl-M as seed treatment can become less optimized against oomycetes, and more particularly against diseases caused by Pythium species.

Therefore, the aim of the present invention is to overcome the problems of the prior art techniques by proposing a new plant propagation material treatment, guaranteeing a good efficacy against oomycetes.

To this end, a first object of the present invention relates to a method of controlling, limiting or preventing an infestation (or infection) of a plant by oomycetes, which comprises applying to propagation material of said plant, a phosphorus-based compound as active ingredient, and preferably a fungicidally effective amount of a phosphorus-based compound, optionally together with one or more customary formulation adjuvant(s).

A second object of the present invention relates to a method of controlling, limiting or preventing an infestation of a plant by oomycetes, which comprises applying to propagation material of said plant, a copper-based compound as active ingredient, and preferably a fungicidally effective amount of a copper-based compound, optionally together with one or more customary formulation adjuvant(s).

A third object of the present invention relates to a method of controlling, limiting or preventing an infestation of a plant by oomycetes, which comprises applying to propagation material of said plant, a phosphorus-based compound and a copper-based compound, and preferably a fungicidally effective amount of a phosphorus-based compound and a fungicidally effective amount of a copper-based compound, optionally together with one or more customary formulation adjuvant(s). The application of the phosphorus-based compound and the copper-based compound can be done in any desired sequence or simultaneously, and preferably simultaneously.

Controlling, limiting or preventing and its inflections, within the context of the present invention, mean reducing any undesired effect, such as pathogenic, and especially phytopathogenic such as oomycetes, infestation or attack of, and pathogenic damage on plant propagation material to such a level that an improvement is demonstrated.

The method according to the present invention has advantageous properties for protecting plants against pathogenic, such as phytopathogenic, especially oomycetes, attack or infestation, which result in a disease and damage to the plant; particularly in instance of plants, the present invention can control, limit or prevent pathogenic damage on a seed, parts of plant and/or plant grown from the treated seed.

The method according to the present invention has particularly advantageous levels of biological activity as plant propagation material treatment, against oomycetes.

Thanks to the present invention, the method can be applied with a phosphorus-based compound and/or a copper-based compound, as fungicide replacement to Metalaxyl-M in order to avoid using Metalaxyl-M.

In a further embodiment, the method according to the present invention can be advantageously applied with a phosphorus-based compound and/or a copper-based compound, combined with Metalaxyl-M, more particularly in using a lower or limited amount of Metalaxyl-M. Preferably, the application to plant propagation material can further comprise a fungicidally effective amount of Metalaxyl-M.

In said further embodiment, the active ingredient application (i.e. the applying step of the active ingredient(s) to plant propagation material), such as:
the application of the phosphorus-based compound and Metalaxyl-M, or
the application of the copper-based compound and Metalaxyl-M, or
the application of the phosphorus-based compound, the copper-based compound and Metalaxyl-M,
   can be done in any desired sequence or simultaneously, and preferably simultaneously.

In a particular embodiment, the method according to the present invention can comprise applying to plant propagation material a combination of a phosphorus-based compound and Metalaxyl-M, and preferably a fungicidally effective amount of a combination comprising a phosphorus-based compound and Metalaxyl-M, in any desired sequence or simultaneously.

In another particular embodiment, the method according to the present invention can comprise applying to plant propagation material a combination of a copper-based compound and Metalaxyl-M, and preferably a fungicidally effective amount of a combination comprising a copper-based compound and Metalaxyl-M, in any desired sequence or simultaneously.

Metalaxyl-M is a fungicide with the following CAS number: 70630-17-0, also well-known under the name of Mefenoxam, and has the following chemical formula:

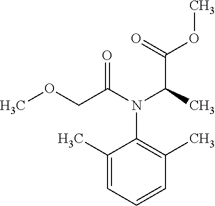

In a particular embodiment, Metalaxyl can be used knowing that Metalaxyl is a racemic mixture of the (R) and(S) enantiomers, so that it comprises metalaxyl-M which is the (R)-Metalaxyl.

In a further embodiment, the method according to the present invention can be advantageously applied with a phosphorus-based compound and/or a copper-based compound, combined with Inpyrfluxam. Preferably, the application to plant propagation material can further comprise a fungicidally effective amount of Inpyrfluxam.

In said further embodiment, the active ingredient application (i.e. the applying step of the active ingredient(s) to plant propagation material), such as:
the application of the phosphorus-based compound and Inpyrfluxam, or
the application of the copper-based compound and Inpyrfluxam or
the application of the phosphorus-based compound, the copper-based compound and Inpyrfluxam, can be done in any desired sequence or simultaneously, and preferably simultaneously.

In a particular embodiment, the method according to the present invention can comprise applying to plant propagation material a combination of a phosphorus-based compound and Inpyrfluxam, and preferably a fungicidally effective amount of a combination comprising a phosphorus-based compound and Inpyrfluxam, in any desired sequence or simultaneously.

In another particular embodiment, the method according to the present invention can comprise applying to plant propagation material a combination of a copper-based compound and Inpyrfluxam, and preferably a fungicidally effective amount of a combination comprising a copper-based compound and Inpyrfluxam, in any desired sequence or simultaneously.

Inpyrfluxam is a fungicide with the following CAS number: 1352994-67-2.

In another particular embodiment, the method according to the present invention can comprise applying to plant propagation material a combination of a phosphorus-based compound, Mefenoxam and Inpyrfluxam, or a combination of copper-based compound, Mefenoxam and Inpyrfluxam, preferably each in a fungicidally effective amount, in any desired sequence or simultaneously.

The plant according to the present invention can be selected among vegetables, leafy vegetables, legume crops, oil crops, beets, fibre plants, and cereals, and preferably from vegetables, leafy vegetables, and cereals.

The phosphorus-based compound according to the present invention can be an oxidized form of phosphorus, such as a phosphonate, and more particularly a phosphonate salt, or phosphonic acid. The phosphonate may preferably include at least one functional group characterized by a phosphorus atom bonded to three oxygen atoms. The term “phosphonate” can also refer to as “phosphite”.

Phosphonate can be made of the salts or esters of phosphorous acid (or phosphonic acid), and can include alkyl phosphonate.

More particularly, the phosphorus-based compound can be a phosphonate salt, and more particularly a phosphonate salt of potassium, sodium, calcium, aluminium, or ammonium.

For example, the phosphorus-based compound can be selected among phosphorus pentoxide, dipotassium phosphonate, monopotassium phosphonate, disodium phosphonate, calcium phosphonate, ammonium methyl phosphonate, diammonium phosphonate, aluminium tri (ethyl phosphonate), phosphonic acid, and any mixture thereof. Phosphorus-based compounds can be commercially available products, such as the technical active ingredient, or a formulated product including the active ingredient.

As the term “phosphonate” can also refer to as “phosphite”, the expressions dipotassium phosphonate, monopotassium phosphonate, disodium phosphonate, calcium phosphonate, ammonium methyl phosphonate, diammonium phosphonate, and aluminium tri (ethyl phosphonate), can also be understood as dipotassium phosphite, monopotassium phosphite, disodium phosphite, calcium phosphite, ammonium methyl phosphite, diammonium phosphite, aluminium tri (ethyl phosphite).

The copper-based compound according to the present invention can be selected among copper hydroxychloride (or copper oxychloride), copper sulfate, copper hydroxide, any mixture thereof. Copper-based compounds can be commercially available products, such as the technical active ingredient, or a formulated product including the active ingredient.

In a particular embodiment, vegetables can be selected among asparagus, eggplant, broccoli, cabbage, carrot, cucumber, garlic, marrow, melon, okra, onion, pepper, potato, pumpkin, rhubarb, spinach, tomato, lettuce, chard, celery, endive, lamb's lettuce, and rucola. The leafy vegetable can be selected among lettuce, chard, spinach, celery, endive, lamb's lettuce, and rucola. The preferred vegetable can be spinach or carrot.

In another particular embodiment, the legume crop can be selected among beans, lentils, peas, and soya (e.g. soybean). The preferred legume crop can be soybean, peas, or Phaseolus bean.

In another particular embodiment, the oil crop can be selected among oilseed rape, mustard, poppies, olives, sunflowers, coconut, castor, cocoa, and ground nuts. The preferred oil crop is sunflower.

In another particular embodiment, the beet can be selected among sugar beet, fodder beet, and red beet.

In another particular embodiment, the fibre plant can be selected among cotton, flax, hemp, and jute.

In another particular embodiment, the cereal can be selected among wheat, barley, rye, oats and maize, maize being the preferred cereal. Maize can be selected among field corn, popcorn, corn, rice, sorghum and related crops. The preferred cereal can be corn.

In the present invention, propagation material of a plant can be understood to denote all the generative parts of the plant, such as seeds, which can be used for the multiplication of the latter including vegetative plant material such as cuttings. There may be mentioned, as plant propagation material, seeds (in the strict sense), roots, fruits, tubers, bulbs, rhizomes, parts of plants. The plant propagation material can be treated with the active ingredient(s) of the invention before the material is sown or planted. Alternatively, the plant propagation material may be treated with the active ingredient(s) of the invention during sowing or planting. Additionally, the active ingredient(s) of the invention may be applied to the previously treated propagation material before or during its planting. The active ingredient(s) of the invention may be applied during the sowing of the seed. The active ingredient(s) may also be used to plant propagation material derived from plants grown in a green house and/or during transplantation.

More preferably the plant propagation material is plant seeds. In a preferred embodiment, the plant propagation material can be spinach seeds and/or corn seeds.

The seed treatment can occur to an unsown seed, and the term “unsown seed” is meant to include seed at any period between the harvest of the seed and the sowing of the seed in the ground for the purpose of germination and growth of the plant. Treatment to an unsown seed is not meant to include those practices in which the pesticide is applied to the soil but would include any application practice that would target the seed during the sowing/planting process.

The treated plant propagation material of the present invention can be treated in the same manner as conventional plant propagation material. The treated propagation material can be stored, handled, sown and tilled in the same manner as any other pesticide treated material.

In the present invention, the application rate can be from 1 gram to 500 grams of phosphorus-based compound, preferably from 10 grams to 400 grams of phosphorus-based compound, and more preferably from 20 grams to 300 grams of phosphorus-based compound, over 100 kg of plant propagation material.

In the present invention, the application rate can be from 1 gram to 1000 grams of copper-based compound, preferably from 10 grams to 500 grams of copper-based compound, and more preferably from 20 grams to 300 grams of copper-based compound, over 100 kg of plant propagation material.

When the application to plant propagation material comprises a phosphorus-based compound and a copper-based compound, the above-mentioned rates can be applied respectively.

When the application to plant propagation material comprises Metalaxyl-M, the application rate can be from 0.1 gram to 100 grams of Metalaxyl-M, preferably from 0.5 gram to 50 grams of Metalaxyl-M, and more preferably from 1 gram to 20 grams of Metalaxyl-M, over 100 kg of plant propagation material.

In a particular embodiment, when the application to plant propagation material comprises a phosphorus-based compound and Metalaxyl-M, the application rate can be:
from 1 gram to 500 grams of phosphorus-based compound, preferably from 10 grams to 400 grams of phosphorus-based compound, and more preferably from 20 grams to 300 grams, over 100 kg of plant propagation material, and
from 0.1 gram to 100 grams of Metalaxyl-M, preferably from 0.5 gram to 50 grams of Metalaxyl-M, and more preferably from 1 gram to 20 grams of Metalaxyl-M, over 100 kg of plant propagation material.

The application rate can advantageously comprise a weight ratio of the phosphorus-based compound to Metalaxyl-M selected from 1/100 to 5000/1, preferably from 1/10 to 1000/1, preferably from 1/5 to 800/1, and more preferably from 1/1 to 300/1.

When the application to plant propagation material comprises Inpyrfluxam, the application rate can be from 0.1 gram to 100 grams of Inpyrfluxam, preferably from 0.5 gram to 50 grams of Inpyrfluxam, and more preferably from 1 gram to 20 grams of Inpyrfluxam, over 100 kg of plant propagation material.

In a particular embodiment, when the application to plant propagation material comprises a phosphorus-based compound and Inpyrfluxam, the application rate can be:
from 1 gram to 500 grams of phosphorus-based compound, preferably from 10 grams to 400 grams of phosphorus-based compound, and more preferably from 20 grams to 300 grams, over 100 kg of plant propagation material, and
from 0.1 gram to 100 grams of Inpyrfluxam, preferably from 0.5 gram to 50 grams of Inpyrfluxam, and more preferably from 1 gram to 20 grams of Inpyrfluxam, over 100 kg of plant propagation material.

The application rate can advantageously comprise a weight ratio of the phosphorus-based compound to Inpyrfluxam selected from 1/100 to 5000/1, preferably from 1/10 to 1000/1, preferably from 1/5 to 800/1, and more preferably from 1/1 to 300/1.

In the present invention, oomycetes are phytopathogenic diseases and can include Phytophthora diseases such as those caused by Phytophthora capsici, Phytophthora infestans, Phytophthora sojae, Phytophthora fragariae, Phytophthora nicotianae, Phytophthora cinnamomi, Phytophthora citricola, Phytophthora citrophthora and Phytophthora erythroseptica; Pythium diseases such as those caused by Pythium aphanidermatum, Pythium arrhenomanes, Pythium attrantheridium, Pythium heterothallcium, Pythium intermedium, Pythium parocecandrum, Pythium spinosum, Pythium sylvaticum, Pythium lutarium, Pythium mamillatum, Pythium graminicola, Pythium irregulare and Pythium ultimum; diseases caused by Peronosporales such as Peronospora destructor, Peronospora parasitica, Plasmopara viticola, Plasmopara halstedii, Pseudoperonospora cubensis, Albugo candida, Sclerophthora macrospora and Bremia lactucae; and others such as Aphanomyces cochlioides, Labyrinthula zosterae, Peronosclerospora sorghi and Sclerospora graminicola.

More preferably, oomycetes can be Pythium diseases, or in other words Pythium spp., such as those caused by Pythium aphanidermatum, Pythium arrhenomanes, Pythium attrantheridium, Pythium heterothallcium, Pythium intermedium, Pythium parocecandrum, Pythium spinosum, Pythium sylvaticum, Pythium lutarium, Pythium mamillatum, Pythium graminicola, Pythium irregulare and Pythium ultimum. In a preferred embodiment, the Pythium diseases can be Pythium ultimum.

According to the present invention, the active ingredient(s) can be advantageously in the form of a soluble concentrate (SL) or a flowable concentrate for seed treatment (FS) or a suspension concentrate (SC), and can be more preferably a seed treatment slurry to be applied onto seeds. Slurries for seed treatment applications are well-known in the art. For example, a slurry can contain the active ingredient(s), in the form of a commercially available product or not, mixed with water and optionally with at least one polymer as described in the present invention, to optimize adhesion around the plant propagation material.

In the method of the present invention, the active ingredient(s) can be generally in the form of a composition or formulation containing other customary formulation adjuvants because it allows, for example, less burdensome handling and application.

In the present invention, the expression “active ingredient(s)” means the phosphorus-based compound and/or the copper-based compound, and Metalaxyl-M and/or Inpyrfluxam when added into the application, as defined above.

Each active ingredient can be applied to the plant propagation material from different compositions respectively, or the active ingredients can be gathered in the same composition (ready-mix composition). The composition may contain from about 0.001% to about 99% by weight of the active ingredient(s) over the total weight of the composition. Suitably, the composition contains from about 0.001% to about 50% by weight active ingredient(s) over the total weight of the composition. More suitably, the composition contains from about 0.001% to about 10% by weight active ingredient(s) over the total weight of the composition. More suitably, the composition contains from about 0.001% to about 1% by weight active ingredient(s) over the total weight of the composition. If the formulation is in the form of a concentrate, requiring dilution with water before use, it will contain a higher amount of active ingredients than a composition that is ready to use without dilution.

The active ingredient(s) according to the invention can be used as pesticidal agents in unmodified form, but they are generally formulated into compositions in various ways using formulation adjuvants, such as liquid carriers (or solvents), solid carriers, and surface-active substances. Such formulations can either be used directly or diluted prior to use. The dilutions can be made, for example, with water, liquid fertilizers, micronutrients, biological organisms, oil and/or solvents.

The formulations can be prepared e.g. by mixing the active ingredient(s) with the formulation adjuvants in order to obtain compositions in the form of finely divided solids, granules, solutions, dispersions or emulsions. The active ingredients can also be formulated with other adjuvants, such as finely divided solids, mineral oils, oils of vegetable or animal origin, modified oils of vegetable or animal origin, organic solvents, water, surface-active substances, or any mixture thereof.

The formulation adjuvants that are suitable for the preparation of the compositions according to the invention are known per se.

As liquid carriers there may be used: water, toluene, xylene, petroleum ether, vegetable oils, acetone, methyl ethyl ketone, cyclohexanone, acid anhydrides, acetonitrile, acetophenone, amyl acetate, 2-butanone, butylene carbonate, chlorobenzene, cyclohexane, cyclohexanol, alkyl esters of acetic acid, diacetone alcohol, 1,2-dichloropropane, diethanolamine, p-diethylbenzene, diethylene glycol, diethylene glycol abietate, diethylene glycol butyl ether, diethylene glycol ethyl ether, diethylene glycol methyl ether, N,N-dimethylformamide, dimethyl sulfoxide, 1,4-dioxane, dipropylene glycol, dipropylene glycol methyl ether, dipropylene glycol dibenzoate, diproxitol, alkylpyrrolidone, ethyl acetate, 2-ethylhexanol, ethylene carbonate, 1,1,1-trichloroethane, 2-heptanone, alpha-pinene, d-limonene, ethyl lactate, ethylene glycol, ethylene glycol butyl ether, ethylene glycol methyl ether, gamma-butyrolactone, glycerol, glycerol acetate, glycerol diacetate, glycerol triacetate, hexadecane, hexylene glycol, isoamyl acetate, isobornyl acetate, isooctane, isophorone, isopropylbenzene, isopropyl myristate, lactic acid, laurylamine, mesityl oxide, methoxypropanol, methyl isoamyl ketone, methyl isobutyl ketone, methyl laurate, methyl octanoate, methyl oleate, methylene chloride, m-xylene, n-hexane, n-octylamine, octadecanoic acid, octylamine acetate, oleic acid, oleylamine, o-xylene, phenol, polyethylene glycol, propionic acid, propyl lactate, propylene carbonate, propylene glycol, propylene glycol methyl ether, p-xylene, toluene, triethyl phosphate, triethylene glycol, xylenesulfonic acid, paraffin, mineral oil, trichloroethylene, perchloroethylene, ethyl acetate, amyl acetate, butyl acetate, propylene glycol methyl ether, diethylene glycol methyl ether, methanol, ethanol, isopropanol, and alcohols of higher molecular weight, such as amyl alcohol, tetrahydrofurfuryl alcohol, hexanol, octanol, ethylene glycol, propylene glycol, glycerol, N-methyl-2-pyrrolidone and the like.

The solid carrier can be a natural or synthetic solid material that is insoluble in water. This carrier is generally inert and acceptable in agriculture, especially on the treated seed or other propagation material. It can be chosen, for example, from clay, diatomaceous earth, natural or synthetic silicates, titanium dioxide, magnesium silicate, aluminum silicate, talc, pyrophyllite clay, silica, attapulgite clay, kieselguhr, chalk, limestone, calcium carbonate, calcium montmorillonite, bentonite clay, Fuller's earth, cottonseed husks, wheat flour, soybean flour, pumice, wood flour, ground walnut shells, lignin, and the like.

A large number of surface-active substances can advantageously be used in both solid and liquid formulations, especially in those formulations which can be diluted with a carrier prior to use. Surface-active substances may be anionic, cationic, non-ionic or polymeric, and they can be used as emulsifiers, wetting agents or suspending agents or for other purposes. Typical surface-active substances include, for example, salts of alkyl sulfates, such as diethanolammonium lauryl sulfate; salts of alkylarylsulfonates, such as calcium dodecyl-benzenesulfonate; alkylphenol/alkylene oxide addition products, such as nonylphenol ethoxylate; alcohol/alkylene oxide addition products, such as tridecylalcohol ethoxylate; soaps, such as sodium stearate; salts of alkylnaphthalenesulfonates, such as sodium dibutylnaphthalenesulfonate; dialkyl esters of sulfosuccinate salts, such as sodium di(2-ethylhexyl) sulfosuccinate; sorbitol esters, such as sorbitol oleate; quaternary amines, such as lauryltrimethylammonium chloride, polyethylene glycol esters of fatty acids, such as polyethylene glycol stearate; block copolymers of ethylene oxide and propylene oxide; and salts of mono- and di-alkylphosphate esters; and also further substances described e.g. in McCutcheon's Detergents and Emulsifiers Annual, MC Publishing Corp., Ridgewood New Jersey (1981).

Further adjuvants that can be used in pesticidal formulations include crystallisation inhibitors, viscosity modifiers, suspending agents, dyes, anti-oxidants, foaming agents, light absorbers, mixing auxiliaries, antifoams, complexing agents, neutralising or pH-modifying substances and buffers, corrosion inhibitors, fragrances, wetting agents, take-up enhancers, micronutrients, plasticisers, glidants, lubricants, dispersants, thickeners, antifreezes, microbicides, and liquid and solid fertilisers.

The composition according to the present invention generally comprises from 1 to 99.9% by weight of a formulation adjuvant over the total weight of the composition, which preferably includes from 0 to 25% by weight of a surface-active substance over the total weight of the composition. Whereas commercial products may preferably be formulated as concentrates, the end user will normally employ dilute formulations.

The composition of the present invention may further comprise an additional agrochemical. The additional agrochemical can be an insecticide, a fungicide, an herbicide, a synergist, a plant growth regulator, a nematicide, a plant nutrient, a plant fertilizer, and a mixture thereof.

Even distribution of the composition of the invention and adherence thereof to the propagation material is desired during the treatment process, this is particularly preferable when the propagation material is a seed. The treatment could vary from a thin film of the formulation containing the composition of the invention on a plant propagation material, such as a seed, where the original size and/or shape are recognizable to a thick film (such as a coating or pelleting with many layers of different materials (such as carriers, for example, clays; different formulations, such as of active ingredients; polymers; and colourants)) where the original shape and/or size of the seed is no longer recognisable.

More particularly, said thin film can be a film-forming polymer well-known in the art. The composition can include at least one polymer selected from water-soluble and water-dispersible film-forming polymers. Suitable polymers have an average molecular weight of at least about 1,000 up to about 100,000; more specifically at least about 5,000, up to about 100,000. The aqueous compositions generally contain from about 0.5% to about 10% by weight of the composition of polymer (b). In a specific embodiment, the compositions contain from about 1.0% up to about 5% by weight of a film-forming polymer. Suitable polymers are selected from alkyleneoxide random and block copolymers such as ethylene oxide-propylene oxide block copolymers (EO/PO block copolymers) including both EO-PO-EO and PO-EO-PO block copolymers; ethylene oxide-butylene oxide random and block copolymers; C2-6 alkyl adducts of ethylene oxide-propylene oxide random and block copolymers; C2-6 alkyl adducts of ethylene oxide-butylene oxide random and block copolymers; polyoxyethylene-polyoxypropylene monoalkylethers such as methyl ether, ethyl ether, propyl ether, butyl ether or mixture thereof; vinylacetate/vinylpyrrolidone copolymers; alkylated vinylpyrrolidone copolymers; polyvinylpyrrolidone; polyalkyleneglycol including the polypropylene glycols and polyethylene glycols; and any mixture thereof. Specific examples of suitable polymers include Pluronic P103 (BASF) (EO-PO-EO block copolymer), Pluronic P65 (BASF) (EO-PO-EO block copolymer), Pluronic P108 (BASF) (EO-PO-EO block copolymer), Vinamul 18160 (National Starch) (polyvinylacetate), Agrimer 30 (ISP) (polyvinylpyrrolidone), Agrimer VA7w (ISP) (vinyl acetate/vinylpyrrolidone copolymer), Agrimer AL 10 (ISP) (alkylated vinylpyrrolidone copolymer), PEG 400 (Uniqema) (polyethylene glycol), Pluronic R 25R2 (BASF) (PO-EO-PO block copolymer), Pluronic R 31R1 (BASF) (PO-EO-PO block copolymer) and Witconol NS 500LQ (Witco) (butanol PO-EO copolymer).

Accordingly, the active ingredient(s) of the invention, and more preferably the composition(s) comprising the active ingredient(s), can preferably adhere to the propagation material, such as a seed.

Although it is believed that the present method can be applied to a seed in any physiological state, it is preferred that the seed be in a sufficiently durable state that it incurs no damage during the treatment process. Typically, the seed would be a seed that had been harvested from the field; removed from the plant; and separated from any cob, stalk, outer husk, and surrounding pulp or other non-seed plant material. The seed would preferably also be biologically stable to the extent that the treatment would cause no biological damage to the seed. It is believed that the treatment can be applied to the seed at any time between harvest of the seed and sowing of the seed or during the sowing process (seed directed applications).

The composition according to the present invention can be applied to seeds using conventional treating techniques and machines, such as fluidized bed techniques, the roller mill method, rotostatic seed treaters, and drum coaters. Other methods, such as spouted beds may also be useful. The seeds may be pre-sized before coating. After coating, the seeds are typically dried and then transferred to a sizing machine for sizing. Such procedures are known in the art and are set out in more detail below.

The composition used in the method according to the present invention can be called a dressing composition, which relates to a liquid composition useful for covering and/or wetting a plant propagation material, and more preferably a seed, at least in part or in totality.

The composition according to the present invention is particularly suited for dressing applications on plant propagation material, especially on seeds. The techniques of seed treatment application are well known to those skilled in the art, and they may be used readily in the context of the present invention. The compositions of the invention is applied to the seed as slurry or a soak. There also may be mentioned, e.g., film coating or encapsulation. The coating processes are well known in the art, and employ, for seeds, the techniques of film coating or encapsulation, or for the other multiplication products, the techniques of immersion.

One method of applying the composition according to the invention consists in spraying or wetting the plant propagation material with the aqueous liquid preparation, or mixing the plant material with such liquid preparation. Also, before the application, the composition of the invention may be diluted with water by simple mixing at ambient temperature in order to prepare an on-farm seed treatment formulation.

Typically, a tank-mix formulation for seed treatment application comprises 0.25% to 80% by weight, especially 1 to 75% by weight, of active ingredient(s), and 99.75% to 20% by weight, especially 99% to 25% by weight, of a solid or liquid auxiliary (including, for example, a solvent such as water), where the auxiliaries can be a surfactant in an amount of 0 to 40% by weight, especially 0.5 to 30% by weight, based on the total weight of the tank-mix formulation.

Typically, a pre-mix formulation for seed treatment application comprises 0.5 to 99.9% by weight, especially 1 to 95% by weight, of active ingredient(s), and 99.5 to 0.1% by weight, especially 99 to 5% by weight, of a solid or liquid adjuvant (including, for example, a solvent such as water), where the auxiliaries can be a surfactant in an amount of 0 to 50% by weight, especially 0.5 to 40% by weight, based on the total weight of the pre-mix formulation.

Whereas commercial products will preferably be formulated as concentrates (e.g., pre-mix composition (formulation)), the end user will normally employ dilute formulations (e.g., tank mix composition).

Preferred formulations can have the following compositions (weight %):

### Emulsifiable Concentrates:

active ingredient: 1 to 95%, preferably 60 to 90%
surface-active agent: 1 to 30%, preferably 5 to 20%
liquid carrier: 1 to 80%, preferably 1 to 35%

### Dusts:

active ingredient: 0.1 to 10%, preferably 0.1 to 5%
solid carrier: 99.9 to 90%, preferably 99.9 to 99%

### Suspension Concentrates:

active ingredient: 5 to 75%, preferably 10 to 50%
water: 94 to 24%, preferably 88 to 30%
surface-active agent: 1 to 40%, preferably 2 to 30%

### Wettable Powders:

active ingredient: 0.5 to 90%, preferably 1 to 80%
surface-active agent: 0.5 to 20%, preferably 1 to 15%
solid carrier: 5 to 95%, preferably 15 to 90%

### Granules:

active ingredient: 0.1 to 30%, preferably 0.1 to 15%
solid carrier: 99.5 to 70%, preferably 97 to 85%

### Flowable Concentrates for Seed Treatment:

active ingredient: 1 to 75%, preferably 10 to 50%
water: 98 to 24%, preferably 88 to 30%
surface-active agent: 1 to 30%, preferably 2 to 20%

### Soluble Concentrate:

active ingredient: 1 to 95%, preferably 10 to 80%
liquid carrier: 5 to 99%, preferably 20 to 90%

The following Examples further illustrate, but do not limit, the invention.

| Wettable powders | a) | b) | c) |
|---|---|---|---|
| active ingredients | 25% | 50% | 75% |
| sodium lignosulfonate | 5% | 5% | — |
| sodium lauryl sulfate | 3% | — | 5% |
| sodium diisobutylnaphthalenesulfonate | — | 6% | 10% |
| phenol polyethylene glycol ether | — | 2% | — |
| (7-8 mol of ethylene oxide) | | | |
| highly dispersed silicic acid | 5% | 10% | 10% |
| Kaolin | 62% | 27% | — |

The combination is thoroughly mixed with the adjuvants and the mixture is thoroughly ground in a suitable mill, affording wettable powders that can be diluted with water to give suspensions of the desired concentration.

| Powders for dry seed treatment | a) | b) | c) |
|---|---|---|---|
| active ingredients | 25% | 50% | 75% |
| light mineral oil | 5% | 5% | 5% |
| highly dispersed silicic acid | 5% | 5% | — |
| Kaolin | 65% | 40% | — |
| Talcum | — | | 20 |

The combination is thoroughly mixed with the adjuvants and the mixture is thoroughly ground in a suitable mill, affording powders that can be used directly for seed treatment.

| Emulsifiable concentrate | |
|---|---|
| active ingredients | 10% |
| octylphenol polyethylene glycol ether | 3% |
| (4-5 mol of ethylene oxide) | |
| calcium dodecylbenzenesulfonate | 3% |
| castor oil polyglycol ether (35 mol of | 4% |
| ethylene oxide) | |
| Cyclohexanone | 30% |
| xylene mixture | 50% |

Emulsions of any required dilution, which can be used in plant protection, can be obtained from this concentrate by dilution with water.

| Dusts | a) | b) | c) |
|---|---|---|---|
| Active ingredients | 5% | 6% | 4% |
| Talcum | 95% | — | — |
| Kaolin | — | 94% | — |
| mineral filler | — | — | 96% |

Ready-for-use dusts are obtained by mixing the combination with the carrier and grinding the mixture in a suitable mill. Such powders can also be used for dry dressings for seed.

| Extruder granules | |
|---|---|
| Active ingredients | 15% |
| sodium lignosulfonate | 2% |
| carboxymethylcellulose | 1% |
| Kaolin | 82% |

The combination is mixed and ground with the adjuvants, and the mixture is moistened with water. The mixture is extruded and then dried in a stream of air.

| Coated granules | |
|---|---|
| Active ingredients | 8% |
| polyethylene glycol (mol. wt. 200) | 3% |
| Kaolin | 89% |

The finely ground combination is uniformly applied, in a mixer, to the kaolin moistened with polyethylene glycol. Non-dusty coated granules are obtained in this manner.

### Suspension Concentrate

| | |
|---|---|
| active ingredients | 40% |
| propylene glycol | 10% |
| nonylphenol polyethylene glycol ether (15 mol of ethylene | 6% |
| oxide) | |
| Sodium lignosulfonate | 10% |
| carboxymethylcellulose | 1% |
| silicone oil (in the form of a 75% emulsion in water) | 1% |
| Water | 32% |

The finely ground combination is intimately mixed with the adjuvants, giving a suspension concentrate from which suspensions of any desired dilution can be obtained by dilution with water. Using such dilutions, living plants as well as plant propagation material can be treated and protected against infestation by microorganisms, by spraying, pouring or immersion.

### Flowable Concentrate for Seed Treatment

| | |
|---|---|
| active ingredients | 40% |
| propylene glycol | 5% |
| copolymer butanol PO/EO | 2% |
| Tristyrenephenole with 10-20 moles EO | 2% |
| 1,2-benzisothiazolin-3-one (in the form of a 20% solution | 0.5% |
| in water) | |
| monoazo-pigment calcium salt | 5% |
| Silicone oil (in the form of a 75% emulsion in water) | 0.2% |
| Water | 45.3% |

The finely ground combination is intimately mixed with the adjuvants, giving a suspension concentrate from which suspensions of any desired dilution can be obtained by dilution with water. Using such dilutions, living plants as well as plant propagation material can be treated and protected against infestation by microorganisms, by spraying, pouring or immersion.

### Soluble Concentrate

| | |
|---|---|
| active ingredients | 50% |
| polydimethylsiloxane | 0.1% |
| propylene glycol | 5.0% |
| water | 44.9% |

Solution of any required dilution, which can be used in plant protection, can be obtained from this concentrate by dilution with water.

### Slow Release Capsule Suspension

28 parts of the combination are mixed with 2 parts of an aromatic solvent and 7 parts of toluene diisocyanate/polymethylene-polyphenylisocyanate-mixture (8:1). This mixture is emulsified in a mixture of 1.2 parts of polyvinylalcohol, 0.05 parts of a defoamer and 51.6 parts of water until the desired particle size is achieved. To this emulsion a mixture of 2.8 parts 1,6-diaminohexane in 5.3 parts of water is added. The mixture is agitated until the polymerization reaction is completed. The obtained capsule suspension is stabilized by adding 0.25 parts of a thickener and 3 parts of a dispersing agent. The capsule suspension formulation contains 28% of the active ingredients. The medium capsule diameter is 8-15 microns. The resulting formulation is applied to seeds as an aqueous suspension in an apparatus suitable for that purpose.

Another object of the present invention is a use of the active ingredient(s) as described above, as seed treatment, to control, limit or prevent an infestation of a plant, more particularly selected among vegetables, leafy vegetables, legume crops, oil crops, beets, fibre plants, and cereals, by oomycetes. The expression vegetables, leafy vegetables, legume crops, oil crops, beets, fibre plants, cereals and oomycetes as well as the application rates are those as defined in the present invention.

Another object of the present invention is a plant propagation material, such as for example a seed, treated with a phosphorus-based compound and/or a copper-based compound, optionally together with one or more customary formulation adjuvants.

In a preferred embodiment, the plant propagation material can be treated with a combination of a phosphorus-based compound and/or a copper-based compound, and Metalaxyl-M, optionally together with one or more customary formulation adjuvants. In a most preferred embodiment, the plant propagation material can be treated with a combination of a phosphorus-based compound and Metalaxyl-M, optionally together with one or more customary formulation adjuvants.

In a preferred embodiment, the plant propagation material can be treated with a combination of a phosphorus-based compound and/or a copper-based compound, and Inpyrfluxam, optionally together with one or more customary formulation adjuvants. In a most preferred embodiment, the plant propagation material can be treated with a combination of a phosphorus-based compound and Inpyrfluxam, optionally together with one or more customary formulation adjuvants.

Another object of the present invention is a pesticidal combination comprising:
a phosphorus-based compound as active ingredient A, and
Metalaxyl-M or Inpyrfluxam, as active ingredient B, in any desired sequence or simultaneously. Said phosphorus-based compound is as defined in the present invention.

Said combination of active ingredients is preferably a synergistic combination. More particularly, the weight ratio of the active ingredient A to the active ingredient B can be from 1/100 to 20000/1, preferably 1/100 to 5000/1, preferably from 1/10 to 1000/1, preferably from 1/5 to 800/1, and more preferably from 1/1 to 300/1.

Another object of the present invention is a use of said pesticidal combination, against oomycetes, and more preferably against Pythium diseases, such as those defined in the present invention.

Another object of the present invention is a method of controlling, limiting or preventing an infestation of a plant, which comprises applying to a growing locus of said plant, said pesticidal combination, preferably against oomycetes, and more preferably against Pythium diseases, such as those defined in the present invention.

In the present invention, the term “locus” as used herein means fields in or on which plants are growing, or where seeds of cultivated plants are sown, or where seed will be placed into the soil. It includes soil, seeds, and seedlings, as well as established vegetation.

The following non-limiting examples demonstrate the improved behaviour associated with a method according to the present invention.

A synergistic effect exists whenever the action of an active ingredient combination is greater than the sum of the actions of the individual components. The action to be expected E for a given active ingredient combination obeys the so-called COLBY formula and can be calculated as follows (COLBY, S. R. “Calculating synergistic and antagonistic responses of herbicide combination”, Weeds, Vol. 15, pages 20-22; 1967):
ppm=milligrams of active ingredient (=a.i.) per liter of spray mixture
X=% action by active ingredient (A) using p ppm of active ingredient
Y=% action by active ingredient (B) using q ppm of active ingredient.

According to COLBY, the expected (additive) action of active ingredients (A)+(B) using p+q ppm of active ingredient is

$$E = X + Y - \frac{X \cdot Y}{100}$$

If the action actually observed (O) is greater than the expected action (E), then the action of the combination is super-additive, i.e. there is a synergistic effect. In mathematical terms, synergism corresponds to a positive value for the difference of (O-E). In the case of purely complementary addition of activities (expected activity), said difference (O-E) is zero. A negative value of said difference (O-E) signals a loss of activity compared to the expected activity.

### EXAMPLE 1

The objective of this study was to evaluate the activity of phosphorus-based compounds as seed treatment solutions, against Pythium spp. especially Pythium ultimum, on corn seeds.

The following products were tested in greenhouse experiments and are gathered in the below Table 1:
Apron XL (commercialized by Syngenta) is an ES350 formulation (emulsion for seed treatment formulation with 350 g of active ingredient per liter) comprises Metalaxyl-M as active ingredient; and
Veriphos (commercialized by Adama) is a SL755 formulation (soluble concentrate with 755 g of active ingredient per liter) comprising potassium phosphonate (dipotassium phosphonate and monopotassium phosphonate) as active ingredient.

The experiments were performed under controlled conditions in the greenhouse. Corn seeds were treated with a slurry (0.25 g slurry per 50 g seeds) of the test compounds using a Turbula mixer. The slurry is the same for all the examples gathered in Table 1 and comprises the Product of Table 1 mixed with water.

The rate of active ingredient (g AI/100 kg seeds) in Table 1 relates only to the active ingredient which is a phosphorus-based compound according to the invention, except for the example 1.1 which concerns the rate of Metalaxyl-M.

The treated seeds were dried in open bottles at room temperature for 24 h and then stored in paper bags at room temperature until sowing.

Millet seeds were artificially infected with Pythium ultimum mycelium and then incubated at 18° C. in the dark for 14 days. The potting soil (TKS) was mixed with the infected millets (fresh material) at a final concentration of 0.8% v/v inoculum load. Twenty-five seeds per tray (rectangular shape) were sown at a depth of 2 cm. Four replicates (trays) per seed treatment were used. After sowing, trays were covered with a plastic sheet until first plant emergence, which occurred at ˜10 days after sowing (DAS). Irrigation was applied accordingly in order to keep a high soil moisture content.

The following climatic conditions were used throughout the test.
From 1 to 10 DAS: 12° C., dark, 70% relative humidity (RH).
At 11 DAS: 18° C., artificial lights (photoperiod: 14 h), 70% RH.
12 DAS-end: 20° C., artificial lights (photoperiod: 14 h), 70% RH.

The number of emerged plants was monitored over time and the final plant stand was used for the activity calculation.

Table 1 shows the activity (%) of seed treatments based on the final plant stand (19 DAS) in tests performed in the greenhouse under controlled conditions.

TABLE 1

| | | | Rate of active | | |
|---|---|---|---|---|---|
| | Active | | ingredient (g AI/ | Inoculum | Activity |
| Ex. | ingredient | Product | 100 kg seeds) | load (% v/v) | (%) |
| 1.1 | Metalaxyl-M | Apron XL | 2 | 0.8 | 100 |
| 1.2 | Potassium | Veriphos | 200 | 0.8 | 74 |
| | phosphonate | | | | |
| 1.3 | Potassium | Veriphos | 400 | 0.8 | 75 |
| | phosphonate | | | | |

The tested seed treatments according to the method of the invention, which are based on a phosphorus-based compound, guarantee a good efficacy (at least 50%) against Pythium spp. especially Pythium ultimum, on corn seeds.

### EXAMPLE 2

The objective of this study was to evaluate the activity of phosphorus-based compounds and/or copper-based compounds as seed treatment solutions, against Pythium spp. especially Pythium ultimum, on spinach seeds.

The following products were tested in greenhouse experiments and are gathered in the below Table 2:
Apron XL (commercialized by Syngenta) is an ES350 formulation (emulsion for seed treatment formulation with 350 g of active ingredient per liter) comprises Metalaxyl-M as active ingredient; and
Veriphos (commercialized by Adama) is a SL755 formulation (soluble concentrate with 755 g of active ingredient per liter) comprising potassium phosphonate (dipotassium phosphonate and monopotassium phosphonate) as active ingredient.

The experiments were performed under controlled conditions in a climate room. Spinach seeds were treated with a slurry (22.6 g slurry per 1 kg seeds) of the test compounds using a Turbula mixer. The slurry is the same for all the examples gathered in Table 2 and comprises the Product of Table 1 mixed with Maxim 480FS, water and polymer. Maxim 480FS (commercialized by Syngenta) is a FS480 formulation (flowable concentrate for seed treatment with 480 g of active ingredient per liter) comprising fludioxonil as active ingredient. Fludioxonil is not effective against Pythium spp. but acts as a base fungicide treatment against other soil-borne and seed-borne diseases.

The rate of active ingredient (g AI/100 kg seeds) in Table 2 relates only to the active ingredient which is a phosphorus-based compound according to the invention, except for the example 2.1 which concerns the rate of Metalaxyl-M. Fludioxonil contained in Maxim 480FS is not included in the rate of active ingredient in Table 2.

The treated seeds were dried in open bottles at room temperature for 24 h and then stored in paper bags at room temperature until sowing.

Potting soil was artificially infected with Pythium ultimum mycelium. Pythium ultimum was cultured in liquid growth media (960 000 spores/mL). For the infection of the potting soil 200 mL inoculum/L soil was used. Fifty seeds per tray (rectangular shape) were sown at a depth of 2 cm. Four replicates (trays) per seed treatment were used. After sowing, trays were placed in a climate room at constant temperature and humidity until first plant emergence, which occurred at ˜5 days after sowing (DAS). Irrigation was applied accordingly in order to keep a high soil moisture content.

The following climatic conditions were used throughout the test.
From 1 to 21 DAS: 20° C., 16 h light and 8 h night, 70% RH.

The number of emerged plants was monitored over time and the final plant stand was used for the activity calculation.

Table 2 shows the activity (%) of seed treatments based on the final plant stand (21 DAS) in tests performed in the greenhouse under controlled conditions.

TABLE 2

| | | | Rate of active | |
|---|---|---|---|---|
| | Active | | ingredient (g AI/ | Activity |
| Ex. | ingredient | Product | 100 kg seeds) | (%) |
| 2.1 | Metalaxyl-M | Apron XL | 70 | 46 |
| 2.2 | Potassium | Veriphos | 528 | 47 |
| | phosphonate | | | |

The tested seed treatments according to the method of the invention, which are based on a phosphorus-based compound and/or a copper-based compound, guarantee a good efficacy against Pythium spp. especially Pythium ultimum, on spinach seeds.

### EXAMPLE 3

The objective of this study was to evaluate the activity of the combination comprising a phosphorus-based compound and Metalaxy-M, or the combination comprising a phosphorus-based compound and Inpyrfluxam, against Pythium spp. especially Pythium ultimum.

The following products were tested in laboratory experiments and are gathered in the below Table 3:
Mefenoxam (CAS-Number: 70630-17-0),
Inpyrfluxam (CAS-Number: 1352994-67-2),
Phosphonic acid of formula H₃O₃P (CAS-Number: 13598-36-2),
Monopotassium phosphite of formula: H₂O₃PK (CAS-Number: 13977-65-6),
Dipotassium phosphite of formula HO₃PK₂ (CAS-Number: 13492-26-7), and
Diammonium phosphonate (or ammonium hydrogenphosphite) of formula H₉N₂O₃P (CAS-Number: 51503-61-8).

Mycelial fragments of Pythium ultimum prepared from a fresh liquid culture, were directly mixed into nutrient broth (PDB potato dextrose broth). A DMSO solution of the test compounds was placed into a microtiter plate (96-well format) and the nutrient broth containing the Pythium ultimum spores was added to it. The test plates were incubated at 24° C. and the inhibition of growth was determined after 48 hours.

Table 3 shows the in vitro efficacy (%) of the active ingredients under controlled conditions, against Pythium ultimum.

TABLE 3

| | Rate of active | Mixture | Observed | Expected |
|---|---|---|---|---|
| | ingredient | ratio | efficacy | efficacy |
| Active ingredient(s) | (ppm) | (A:B) | (%) | (%) |
| Diammonium phosphonate | 1000 | — | 70 | — |
| Diammonium phosphonate | 500 | — | 50 | — |
| Inpyrfluxam | 20 | — | 0 | — |
| Monopotassium phosphite | 500 | — | 20 | — |
| Monopotassium phosphite | 250 | — | 20 | — |
| Monopotassium phosphite | 125 | — | 20 | — |
| Mefenoxam | 0.06 | — | 50 | — |
| Mefenoxam | 0.02 | — | 20 | — |
| Mefenoxam | 0.007 | — | 0 | — |
| Diammonium phosphonate (A) | 500 | 25:1 | 70 | 50 |
| Inpyrfluxam (B) | 20 | | | |
| Monopotassium phosphite (A) | 500 | 25000:1 | 50 | 36 |
| Mefenoxam (B) | 0.02 | | | |
| Monopotassium phosphite (A) | 250 | 12500:1 | 50 | 36 |
| Mefenoxam (B) | 0.02 | | | |
| Monopotassium phosphite (A) | 125 | 6250:1 | 50 | 36 |
| Mefenoxam (B) | 0.02 | | | |
| Monopotassium phosphite (A) | 500 | 71429:1 | 50 | 20 |
| Mefenoxam (B) | 0.007 | | | |
| Monopotassium phosphite (A) | 250 | 35714:1 | 50 | 20 |
| Mefenoxam (B) | 0.007 | | | |
| Monopotassium phosphite (A) | 125 | 17857:1 | 50 | 20 |
| Mefenoxam (B) | 0.007 | | | |
| Diammonium phosphonate (A) | 1000 | 16667:1 | 90 | 85 |
| Mefenoxam (B) | 0.06 | | | |

The tested active ingredients according to the invention, which are based on a phosphorus-based compound mixed with either Mefenoxam or Inpyrfluxam, guarantee a good efficacy against Pythium spp. especially Pythium ultimum.

1. A method of controlling, limiting or preventing an infestation of a plant by oomycetes, which comprises applying to propagation material of said plant, a fungicidally effective amount of a phosphorus-based compound.

2. A method according to claim 1, characterized in that the phosphorus-based compound is selected among phosphorus pentoxide, dipotassium phosphonate, monopotassium phosphonate, disodium phosphonate, calcium phosphonate, ammonium methyl phosphonate, diammonium phosphonate, aluminium tri (ethyl phosphonate), phosphonic acid, and any mixture thereof.

3. A method according to claim 1, characterized in that the phosphorus-based compound is a phosphonate salt.

4. A method according to claim 1, characterized in that the plant is selected among vegetables, leafy vegetables, legume crops, oil crops, beets, fibre plants, and cereals.

5. A method according to claim 1, characterized in that the plant is selected among leafy vegetables and cereals.

6. A method according to claim 5, characterized in that the leafy vegetable is selected among lettuce, chard, spinach, and celery, endive, lamb's lettuce, and rucola.

7. A method according to claim 5, characterized in that the cereal is selected among wheat, barley, rye, oats and maize.

8. A method according to claim 1, characterized in that the application rate is from 1 gram to 500 grams of phosphorus-based compound, preferably from 10 grams to 400 grams of phosphorus-based compound, and more preferably from 20 grams to 300 grams of phosphorus-based compound, over 100 kg of plant propagation material

9. A method according to claim 1, characterized in that it further comprises applying to propagation material of said plant a fungicidally effective amount of Metalaxyl-M.

10. A method according to claim 9, characterized in that the application rate is from 0.1 gram to 100 grams of Metalaxyl-M, preferably from 0.5 gram to 50 grams of Metalaxyl-M, and more preferably from 1 gram to 20 grams of Metalaxyl-M, over 100 kg of plant propagation material.

11. A method according to claim 1, characterized in that it further comprises applying to propagation material of said plant a fungicidally effective amount of Inpyrfluxam.

12. A method according to claim 11, characterized in that the application rate is from 0.1 gram to 100 grams of Inpyrfluxam, preferably from 0.5 gram to 50 grams of Inpyrfluxam, and more preferably from 1 gram to 20 grams of Inpyrfluxam, over 100 kg of plant propagation material.

13. A method according to claim 1, characterized in that the oomycetes are Pythium diseases.

14. A method according to claim 1, characterized in that it controls, limits or prevents an infestation of a plant selected from vegetable, leafy vegetable, and cereal, by Pythium ultimum, which comprises applying to propagation material of said plant, a fungicidally effective amount of a phosphorus-based compound selected from phosphonate salts.

15. A method according to claim 1, characterized in that the plant is spinach or maize.

16. A method according to claim 1, characterized in that the plant propagation material is plant seeds.

17. A plant propagation material treated with a phosphorus-based compound, and optionally Metalaxyl-M and/or Inpyrfluxam.

18. A pesticidal combination comprising:
a phosphorus-based compound as active ingredient A, and
Metalaxyl-M or Inpyrfluxam, as active ingredient B,
in any desired sequence or simultaneously.

19. A pesticidal combination according to claim 18, wherein the weight ratio of the active ingredient A to the active ingredient B is from 1/100 to 5000/1, preferably from 1/10 to 1000/1, preferably from 1/5 to 800/1, and more preferably from 1/1 to 300/1.

20. Use of a pesticidal combination according to claim 18, against oomycetes.
